(19) United States
(12) Patent Application Publication
(10) Pub. No.: US 2025/0124812 A1
(43) Pub. Date: Apr. 17, 2025

(54) TRAINING AN OPERATOR OF A VEHICLE TO PERFORM A MANEUVER OF THE VEHICLE

(71) Applicant: Toyota Research Institute, Inc., Los Altos, CA (US)

(72) Inventors: Jean Marcel dos Reis Costa, San Jose, CA (US); Hiroshi Yasuda, San Carlos, CA (US); Tiffany L. Chen, San Jose, CA (US); Guy Rosman, Cambridge, MA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/612,226

(22) Filed: Mar. 21, 2024

Related U.S. Application Data
(60) Provisional application No. 63/589,440, filed on Oct. 11, 2023.

(51) Int. Cl. G09B 19/16; B60W 50/14; B60W 60/00

(52) U.S. Cl. CPC G09B 19/167; B60W 50/14; B60W 60/005

(57) ABSTRACT

A system for training an operator of a vehicle to perform a maneuver of the vehicle can include a processor and a memory. The memory can store an automated motion module, an instruction module, and a communications module. The automated motion module can cause the processor to cause the vehicle to perform, in an automated manner, a first iteration of the maneuver. The instruction module can cause the processor to cause an instruction to be provided to the operator during a second iteration of the maneuver. The communications module can cause the processor to receive, during the second iteration, a query from the operator about a performance of the second iteration. The communications module can cause the processor to communicate a response to the query to train the operator to perform the second iteration or a third iteration of the maneuver in a manner that mimics the first iteration.

This application claims the benefit of U.S. Provisional Application No. 63/589,440, filed Oct. 11, 2023, which is incorporated herein in its entirety by reference.

### TECHNICAL FIELD

The disclosed technologies are directed to training an operator of a vehicle to perform a maneuver of the vehicle.

### BACKGROUND

A degree of a control of a motion of a vehicle, by an operator of the vehicle, during a performance of a specific maneuver of the vehicle can be a function of a degree of a skill of the operator in the performance of the specific maneuver. The degree of the skill can be increased through practice, by the operator, of the specific maneuver. The degree of the skill can also be increased by a receipt, by the operator, of an instruction, from an expert operator of the vehicle, about the performance of the specific maneuver. Often, the expert operator can require compensation for a duration of time in which the expert operator provides the instruction.

### SUMMARY

In an embodiment, a system for training an operator of a vehicle to perform a maneuver of the vehicle can include a processor and a memory. The memory can store an automated motion module, an instruction module, and a communications module. The automated motion module can include instructions that, when executed by the processor, cause the processor to cause the vehicle to perform, in an automated manner, a first iteration of the maneuver. The instruction module can include instructions that, when executed by the processor, cause the processor to cause an instruction to be provided to the operator during a second iteration of the maneuver. The communications module can include instructions that, when executed by the processor, cause the processor to receive, during the second iteration, a query from the operator about a performance of the second iteration. The communications module can include instructions that, when executed by the processor, cause the processor to communicate a response to the query to train the operator to perform the second iteration or a third iteration of the maneuver in a manner that mimics the first iteration.

In another embodiment, a method for training an operator of a vehicle to perform a maneuver of the vehicle can include causing, by a processor, the vehicle to perform, in an automated manner, a first iteration of the maneuver. The method can include causing, by the processor, an instruction to be provided to the operator during a second iteration of the maneuver. The method can include receiving, by the processor and during the second iteration, a query from the operator about a performance of the second iteration. The method can include communicating, by the processor, a response to the query to train the operator to perform the second iteration or a third iteration of the maneuver in a manner that mimics the first iteration.

In another embodiment, a non-transitory computer-readable medium for training an operator of a vehicle to perform a maneuver of the vehicle can include instructions that, when executed by one or more processors, cause the one or more processors to cause the vehicle to perform, in an automated manner, a first iteration of the maneuver. The non-transitory computer-readable medium can include instructions that, when executed by the one or more processors, cause the one or more processors to cause an instruction to be provided to the operator during a second iteration of the maneuver. The non-transitory computer-readable medium can include instructions that, when executed by the one or more processors, cause the one or more processors to receive, during the second iteration, a query from the operator about a performance of the second iteration. The non-transitory computer-readable medium can include instructions that, when executed by the one or more processors, cause the one or more processors to communicate a response to the query to train the operator to perform the second iteration or a third iteration of the maneuver in a manner that mimics the first iteration.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment for training an operator of a vehicle to perform a maneuver of the vehicle, according to the disclosed technologies.

FIG. 2 includes a diagram that illustrates an example of a vehicle configured to train an operator of the vehicle to perform a maneuver of the vehicle, according to the disclosed technologies.

FIG. 3 includes a block diagram that illustrates an example of a system for training an operator of a vehicle to perform a maneuver of the vehicle, according to the disclosed technologies.

FIG. 4 includes graphs that illustrate examples of operations of various car controls to perform a sharp right turn, according to the disclosed technologies.

FIG. 5 includes graphs that illustrate examples of performances of the maneuver, according to the disclosed technologies.

FIG. 6 includes a flow diagram that illustrates an example of a method that is associated with training an operator of a vehicle to perform a maneuver of the vehicle, according to the disclosed technologies.

FIG. 7 includes a block diagram that illustrates an example of elements disposed on a vehicle, according to the disclosed technologies.

### DETAILED DESCRIPTION

The disclosed technologies are directed to training an operator of a vehicle to perform a maneuver of the vehicle. For example, the vehicle can be an automotive vehicle. For example, a performance of the maneuver can include a sequence of operations of various car controls. For example, the vehicle can be configured to be switchable: (1) from a first mode to a second mode and (2) from the second mode to the first mode. For example, the first mode can be a mode in which car controls, required to perform the maneuver, are configured to operate under a control of the operator. For example, the second mode can be a mode in which the car controls, required to perform the maneuver, are configured to operate automatically. Alternatively, for example, the second mode can be a mode in which the vehicle is configured to operate autonomously. The vehicle can be caused to perform, in an automated manner, a first iteration of the maneuver. An instruction can be caused to be provided to the operator during a second iteration of the maneuver. A query from the operator, about a performance of the second iteration, can be received during the second iteration. A response to the query can be communicated to train the operator to perform the maneuver in a manner that mimics the first iteration. For example, the response can be communicated during the second iteration. In this approach, the operator can be trained to perform the maneuver in an interactive manner. Additionally or alternatively, the response can be communicated after the second iteration to train the operator to perform a third iteration of the maneuver in the manner that mimics the first iteration. For example, the response can be communicated to an external communications device.

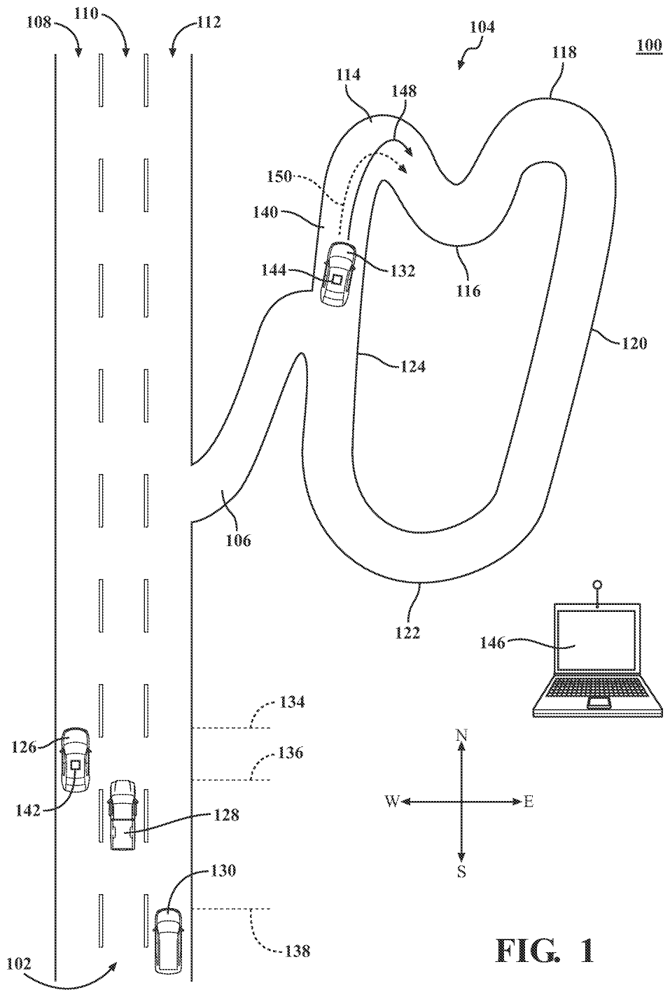

FIG. 1 includes a diagram 100 that illustrates an example of an environment for training an operator of a vehicle to perform a maneuver of the vehicle, according to the disclosed technologies. For example, the diagram 100 can include a road 102 (disposed along a line of longitude) and a race track 104. For example, an interchange 106 (e.g., an offramp) can connect the road 102 to the race track 104. For example, the road 102 can include a first lane 108 for northbound traffic, a second lane 110 for northbound traffic, and a third lane 112 for northbound traffic. For example, the race track 104 can include a first sharp turn 114 (e.g., with an angle of about 160 degrees), a second sharp turn 116 (e.g., with an angle of about 160 degrees), a third sharp turn 118, a first straight portion 120, a gradual curve 122, and a second straight portion 124. For example, the diagram 100 can include a first vehicle 126, a second vehicle 128, a third vehicle 130, and a fourth vehicle 132. For example, the first vehicle 126 can be located in the first lane 108 at a first latitude 134. For example, the second lane 110 can be located in the second lane 110 at a second latitude 136. For example, the second latitude 136 can be about ten yards behind the first latitude 134. For example, the third vehicle 130 can be located in the third lane 112 at a third latitude 138. For example, the third latitude 138 can be about forty yards behind the first latitude 134. For example, the fourth vehicle 132 can be located in a western portion 140 of the first sharp turn 114 and can be moving in a northeasterly direction. For example, the first vehicle 126 can have a communications device 142. For example, the fourth vehicle 132 can have a communications device 144. For example, the diagram 100 can include an external communications device 146.

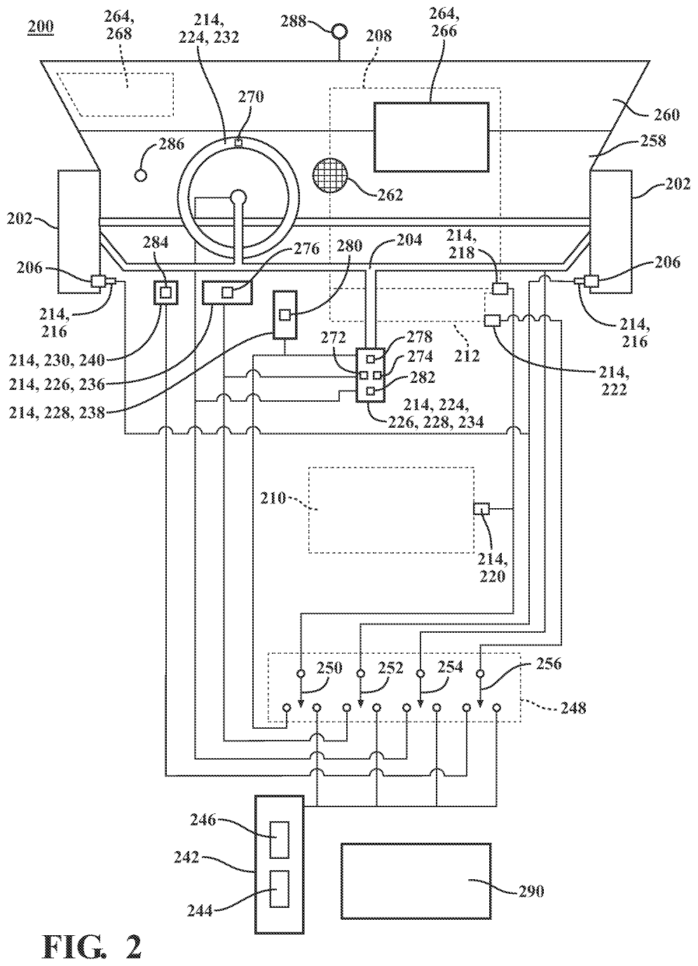

FIG. 2 includes a diagram that illustrates an example of a vehicle 200 configured to train an operator of the vehicle 200 to perform a maneuver of the vehicle 200, according to the disclosed technologies. For example, the vehicle 200 can include one or more wheels 202, a steering linkage 204 connected to the one or more wheels 202, one or more brakes 206 for the one or more wheels 202, at least one of an internal combustion engine 208 or an electric drive motor 210, and a transmission system 212.

For example, the vehicle 200 can include various car controls 214. For example, the car controls 214 can include one or more actuators 216 configured to control the one or more brakes 208, an actuator 218 configured to control a position of a throttle for the internal combustion engine 208 (e.g., if the vehicle 200 is capable of being propelled by the internal combustion engine 208), an actuator 220 configured to control an amount of current conveyed to the electric drive motor 210 (e.g., if the vehicle 200 is capable of being propelled by the electric drive motor 210), and an actuator 222 configured to control the transmission system 212.

For example, the car controls 214 can include one or more of a steering operator interface 224, a brake operator interface 226, an acceleration operator interface 228, or a transmission operator interface 230. For example, the steering operator interface 224 can include a steering wheel 232. Alternatively, for example, the steering operator interface 224 can include a joystick-like control lever 234. For example, the braking operator interface 226 can include a brake pedal 236. Alternatively, for example, the braking operator interface 226 can include the joystick-like control lever 234. For example, the accelerating operator interface 228 can include an accelerator pedal 238. Alternatively, for example, the accelerating operator interface 228 can include the joystick-like control lever 234. For example, the transmission operator interface 230 can include a clutch pedal 240.

For example, the vehicle 200 can include an automated motion technology system 242. For example, the automated motion technology system 242 can include at least one of a trajectory planning stage 244 or an optimal control system 246. For example, the vehicle 200 can include a switching device 248. For example, the switching device 248 can include one or more of a first switch 250, a second switch 252, a third switch 254, or a fourth switch 256. For example, the first switch 250 can be configured to selectively connect one or more of the actuator 218 or the actuator 220 to: (1) the acceleration operator interface 228 or (2) the automated motion technology system 242. For example, the second switch 252 can be configured to selectively connect the one or more actuators 216 to: (1) the braking operator interface 226 or (2) the automated motion technology system 242. For example, the third switch 254 can be configured to selectively connect the steering linkage 204 to: (1) the steering operator interface 224 or (2) the automated motion technology system 242. For example, the fourth switch 256 can be configured to selectively connect the actuator 222 to: (1) the transmission operator interface 230 or (2) the automated motion technology system 242.

For example, the vehicle 200 can include a dashboard 258 and a windshield 260. For example, the vehicle can include a speaker 262. For example, the speaker 262 can be disposed on the dashboard 258. For example, the vehicle 200 can include a display 264. For example, the display 264 can be one or more of a console display 266 (disposed on the dashboard 258) or a head up display 268 (configured to be presented on the windshield 260). For example, the vehicle 200 can include at least one of a steering wheel haptic actuator 270 or a joystick-like control lever left turn haptic actuator 272 and a joystick-like control lever right turn haptic actuator 274. For example, the vehicle 200 can include at least one of a brake pedal haptic actuator 276 or a joystick-like control lever brake haptic actuator 278. For example, the vehicle 200 can include at least one of an accelerator pedal haptic actuator 280 or a joystick-like control lever acceleration haptic actuator 282. For example, the vehicle 200 can include a clutch pedal haptic actuator 284. For example, the vehicle 200 can include a microphone 286. For example, the microphone 286 can be disposed on the dashboard 258.

For example, the vehicle 200 can include a communications device 288.

For example, the vehicle 200 can include a system 290 for training an operator of the vehicle 200 to perform a maneuver of the vehicle 200.

With reference to FIGS. 1 and 2, for example, one or more of: (1) the first vehicle 126, (2) the second vehicle 128, (3) the third vehicle 130, or (4) the fourth vehicle 132 can be the vehicle 200.

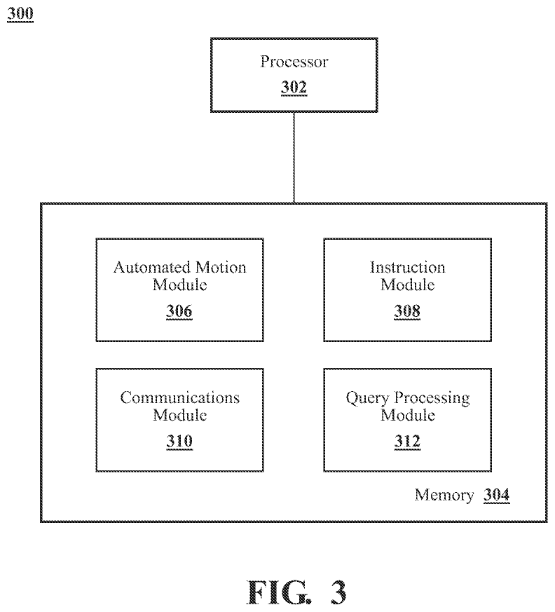

FIG. 3 includes a block diagram that illustrates an example of a system 300 for training an operator of a vehicle to perform a maneuver of the vehicle, according to the disclosed technologies. For example, a performance of the maneuver can include a sequence of operations of various car controls. The system 300 can include, for example, a processor 302 and a memory 304. The memory 304 can be communicably coupled to the processor 302. For example, the memory 304 can store an automated motion module 306, an instruction module 308, and a communications module 310. For example, system 300 can be the system 290 illustrated in FIG. 2.

For example, the automated motion module 306 can include instructions that function to control the processor 302 to cause the vehicle to perform, in an automated manner, a first iteration of the maneuver.

For example, the instruction module 308 can include instructions that function to control the processor 302 to cause an instruction to be provided to the operator during a second iteration of the maneuver.

For example, the communications module 310 can include instructions that function to control the processor 302 to receive, during the second iteration, a query from the operator about a performance of the second iteration.

For example, the communications module 310 can include instructions that function to control the processor 302 to communicate a response to the query to train the operator to perform the second iteration or a third iteration of the maneuver in a manner that mimics the first iteration.

For example, the vehicle can be switchable: (1) from a first mode to a second mode and (2) from the second mode to the first mode. For example, the first mode can be a mode in which car controls, required to perform the maneuver, are configured to operate under a control of the operator. For example, the second mode can be a mode in which the car controls, required to perform the maneuver, are configured to operate automatically. Alternatively, for example, the second mode can be a mode in which the vehicle is configured to operate autonomously.

With reference to FIG. 2, for example, in the first mode, the first switch 250 can be configured to connect one or more of the actuator 218 or the actuator 220 to the acceleration operator interface 228, the second switch 252 can be configured to connect the one or more actuators 216 to the braking operator interface 226, the third switch 254 can be configured to connect the steering linkage 204 to the steering operator interface 224, and the fourth switch 256 can be configured to connect the actuator 222 to the transmission operator interface 230. For example, in the second mode, one or more of the first switch 250 can be configured to connect one or more of the actuator 218 or the actuator 220 to the automated motion technology system 242, the second switch 252 can be configured to connect the one or more actuators 216 to the automated motion technology system 242, the third switch 254 can be configured to connect the steering linkage 204 to the automated motion technology system 242, or the fourth switch 256 can be configured to connect the actuator 222 to the automated motion technology system 242. Alternatively, for example, in the second mode, the first switch 250 can be configured to connect one or more of the actuator 218 or the actuator 220 to the automated motion technology system 242, the second switch 252 can be configured to connect the one or more actuators 216 to the automated motion technology system 242, the third switch 254 can be configured to connect the steering linkage 204 to the automated motion technology system 242, and the fourth switch 256 can be configured to connect the actuator 222 to the automated motion technology system 242.

For example, the instructions to cause the instruction to be provided to the operator can include instructions to cause the instruction to be provided to the operator in one or more of an audible manner, a visual manner, or a haptic manner.

With reference to FIGS. 1-3, for example, the vehicle can be the fourth vehicle 132 (i.e., the vehicle 200), the system 300 can be the system 290, and the instruction can be with respect to a performance of a sharp right turn through the first sharp turn 114.

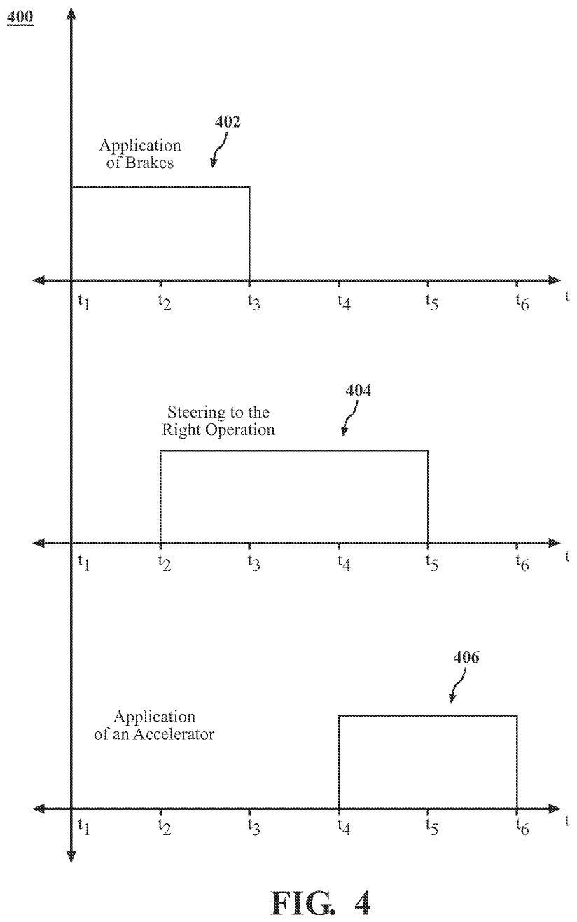

FIG. 4 includes graphs 400 that illustrate examples of operations of various car controls to perform a sharp right turn, according to the disclosed technologies. For example, the graphs 400 can include a first graph 402, a second graph 404, and a third graph 406. For example, the first graph 402 can be of an application of brakes versus time. For example, the application of the brakes can start at a first time (t₁) and end at a third time (t₃). For example, the second graph 404 can be of a steering to the right operation versus time. For example, the steering to the right operation can start at a second time (t₂) and end at a fifth time (t₅). For example, the third graph 406 can be of an application of an accelerator versus time. For example, the application of the accelerator can start at a fourth time (t₄) and end at a sixth time (t₆).

With reference to FIGS. 1-4, for example, the instructions, “Sharp right turn. See head up display. Pay attention to vibratory signals.” can be provided in an audible manner through the speaker 262. For example, the instructions, “Apply brakes. Steer to the right. Apply accelerator.” can be provided in a visual manner on the head up display 268. For example, instructions can be provided in a haptic manner as follows: (1) the brake pedal haptic actuator 276 can be activated from the first time (t₁) to the third time (t₃), (2) the steering wheel haptic actuator 270 can be activated from the second time (t₂) to the fifth time (t₅), and (3) the accelerator pedal haptic actuator 280 can be activated from the fourth time (t₄) to the sixth time (t₆).

With reference to FIGS. 1-3, for example, the vehicle can be the fourth vehicle 132 (i.e., the vehicle 200), the system 300 can be the system 290, the instruction can be with respect to the performance of the sharp right turn through the first sharp turn 114, and the query from the operator, “When do I accelerate?” can be received in an audible manner through the microphone 286.

For example, the instructions to communicate the response to the query include instructions to communicate the response to the query in one or more of an audible manner, a visual manner, or a haptic manner.

For example, the response to the query, “Start to accelerate now.” can be communicated in an audible manner through the speaker 262, in a visual manner on the console display 266, or both. For example, the response to the query can be provided in a haptic manner as follows: (1) the accelerator pedal haptic actuator 280 can be activated at a time at which acceleration should start or (2) if the accelerator pedal haptic actuator 280 has been activated, then an intensity of an energy produced by the accelerator pedal haptic actuator 280 can be changed.

For example, the instructions to communicate the response to the query can include instructions to communicate the response to the query during the second iteration.

Additionally or alternatively, for example, the instructions to communicate the response to the query can include instructions to communicate the response to the query after the second iteration. For example, the response to the query can include a presentation of a graph of a trajectory of a performance of the second iteration of the maneuver. For example, the graph can include an annotation of a time at which acceleration should start. For example, the graph can be used to train the operator to perform the third operation of the maneuver.

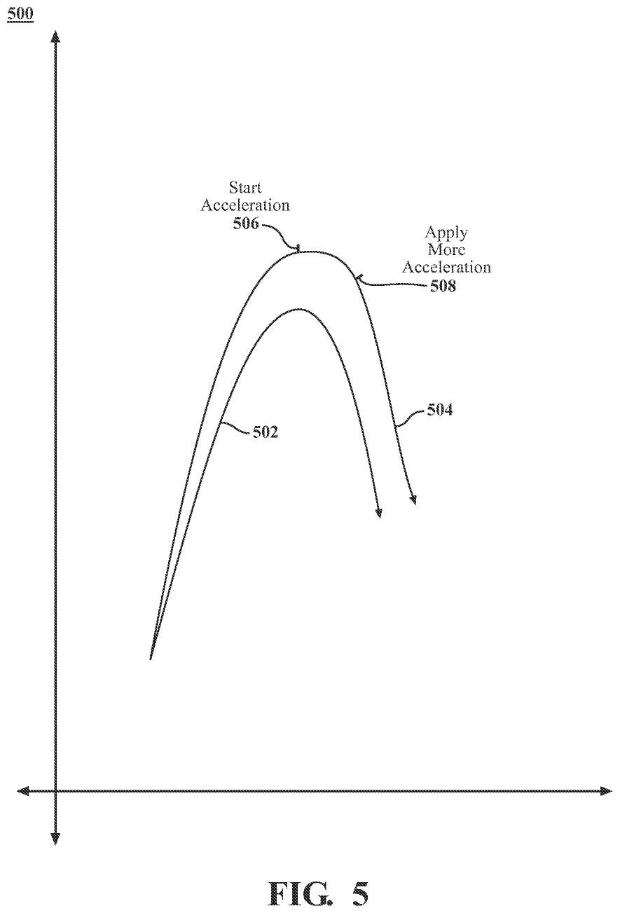

FIG. 5 includes graphs 500 that illustrate examples of performances of the maneuver, according to the disclosed technologies. For example, the graphs 500 can include a first graph 502 and a second graph 504. For example, the first graph 502 can be a graph of a trajectory of a performance, in the automated manner, of the first iteration of the maneuver. For example, the second graph 504 can be the graph of the trajectory of the performance, by the operator, of the second iteration of the maneuver. For example, the second graph 504 can include a first annotation 506. For example, the first annotation 506 can be with respect to a time at which acceleration should start.

For example, the instructions to communicate the response to the query can include instructions to communicate, to an external communications device, the response to the query.

With reference to FIGS. 1-3, for example, the vehicle can be the fourth vehicle 132 (i.e., the vehicle 200), the system 300 can be the system 290, and the response to the query can be communicated from the communications device 144 (i.e., the communications device 288) to the external communications device 146.

For example, one or more of the instruction provided to the operator or the response to the query can be based on a result of a comparison of a measurement of a performance of the maneuver by the operator and a measurement of a performance of the maneuver in the automated manner.

For example, the instructions to communicate the response to the query can include instructions to communicate the response to the query in response to the result of the comparison being greater than a threshold.

For example, the performance of the maneuver by the operator can produce an operator trajectory. For example, the performance of the maneuver in the automated manner can produce a reference trajectory. For example, the result of the comparison can include a measurement of a degree of adherence of the operator trajectory to the reference trajectory.

With reference to FIG. 1, for example, the diagram 100 can include a representation of the operator trajectory 148 and a representation of the reference trajectory 150.

For example, the reference trajectory can include a trajectory of the maneuver performed in the automated manner to mimic one or more of: (1) an example trajectory of the maneuver performed by an expert operator, (2) a trajectory produced by a trajectory planning stage of an automated motion technology system of the vehicle, or (3) a trajectory produced by an optimal control system of the automated motion technology system. For example, the optimal control system can be a model predictive control system.

For example, one or more of: (1) the trajectory produced by the trajectory planning stage or (2) the trajectory produced by the optimal control system can be produced by optimizing an objective function. For example, a significant constraint of the objective function can be one or more of: (1) a duration of time to complete the maneuver or (2) a measurement of a degree of safety associated with the performance of the maneuver.

With reference to FIGS. 1-3, for example, the vehicle can be the fourth vehicle 132 (i.e., the vehicle 200), the system 300 can be the system 290, and maneuver can be the sharp right turn through the first sharp turn 114. For example, the reference trajectory (as illustrated by the representation of the reference trajectory 150) can be produced by optimizing an objective function in which a significant constraint of the objective function can be a duration of time to complete the sharp right turn through the first sharp turn 114. That is, the reference trajectory can be a trajectory in which the objective function is optimized by completing the sharp right turn through the first sharp turn 114 in a manner that minimizes the duration of time.

With reference to FIGS. 1-3, for example, the vehicle can be the first vehicle 126 (i.e., the vehicle 200), the system 300 can be the system 290, and the maneuver can be a sequence of lane changes by the first vehicle 126 in order to exit the road 102 at the interchange 106 (e.g., the offramp). For example, the maneuver can include a sequence in which: (1) the braking operator interface 226 is operated to cause the one or more actuators 216 to control the one or more brakes 208 to cause a speed of the first vehicle 126 to be decreased so that the second vehicle 128 can pass ahead of the first vehicle 126, (2) the steering operator interface 224 is operated to control the steering linkage 204 to cause a path of motion of first vehicle 126 to change from the first lane 108 to the second lane 110, (3) the acceleration operator interface 228 is operated to cause: (a) the actuator 218 (e.g., if the first vehicle 126 is being propelled by the internal combustion engine 208) to control the position of the throttle for the internal combustion engine 208 or (b) the actuator 220 (e.g., if the first vehicle 126 is being propelled by the electric drive motor 210) to control the amount of current conveyed to the electric drive motor 210 to cause the speed of the first vehicle 126 to be increased to be equal to or greater than a speed of the third vehicle 130, and (4) the steering operator interface 224 is operated to control the steering linkage 204 to cause the path of motion of first vehicle 126 to change: (a) from the second lane 110 to the third lane 112 and (b) from the third lane 112 to the interchange 106 (e.g., the offramp). For example, the reference trajectory can be produced by optimizing an objective function in which a significant constraint of the objective function can be a measurement of a degree of safety to complete the sequence of lane changes. That is, the reference trajectory can be a trajectory in which the objective function is optimized by completing the sequence of lane changes in a manner that maximized the measurement of the degree of safety.

Additionally, for example, the communications module 310 can further include instructions to: (1) receive, during the first iteration of the maneuver performed in the automated manner, a query from the operator about a performance of the first iteration and (2) communicate a response to the query from the operator about the performance of the first iteration. For example, the instructions to communicate the response to the query from the operator about the performance of the first iteration can include instructions to communicate the response to the query from the operator about the performance of the first iteration in one or more of an audible manner, a visual manner, or a haptic manner.

With reference to FIGS. 1-3, for example, the vehicle can be the fourth vehicle 132 (i.e., the vehicle 200), the system 300 can be the system 290, the instruction can be with respect to the performance of the sharp right turn through the first sharp turn 114, and the query, during the first iteration of the maneuver performed in the automated manner, from the operator, “Is this when acceleration should start?” can be received in an audible manner through the microphone 286. For example, the response to the query, “Yes, this is when acceleration should start.” can be communicated in an audible manner through the speaker 262, in a visual manner on the console display 266, or both. For example, the response to the query can be provided in a haptic manner as follows: (1) the accelerator pedal haptic actuator 280 can be activated at a time at which acceleration should start or (2) if the accelerator pedal haptic actuator 280 has been activated, then an intensity of an energy produced by the accelerator pedal haptic actuator 280 can be changed.

Additionally, for example, the communications module 310 can further include instructions to receive a signal from the operator. For example, the signal can be different from the query. For example, the instructions to receive the signal from the operator can include instructions to receive the signal from the operator via one or more of a steering operator interface, a brake operator interface, an acceleration operator interface, or a transmission operator interface. For example, the instructions to receive the signal from the operator can include instructions to receive the signal from the operator before the instruction has been provided to the operator. Alternatively, for example, the instructions to receive the signal from the operator can include instructions to receive the signal from the operator after the instruction has been provided to the operator.

With reference to FIGS. 1-4, for example, the vehicle can be the fourth vehicle 132 (i.e., the vehicle 200), the system 300 can be the system 290, and the instruction can be with respect to a performance of the sharp right turn through the first sharp turn 114. For example, the instructions, “Sharp right turn. See head up display. Pay attention to vibratory signals.” can be provided in an audible manner through the speaker 262. For example, the instructions, “Apply brakes. Steer to the right. Apply accelerator.” can be provided in a visual manner on the head up display 268. For example, instructions can be provided in a haptic manner as follows: (1) the brake pedal haptic actuator 276 can be activated from the first time (t₁) to the third time (t₃), (2) the steering wheel haptic actuator 270 can be activated from the second time (t₂) to the fifth time (t₅), and (3) the accelerator pedal haptic actuator 280 can be activated from the fourth time (t₄) to the sixth time (t₆). However, for example, the signal from the operator via the braking operator interface 226 can be received one or more of after the instruction: (1) “Apply brakes.” has been provided to the operator in a visual manner on the head up display 268 or (2) the first time (t₁) (at which the brake pedal haptic actuator 276 has been activated). However, for example, the signal from the operator via the acceleration operator interface 228 can be received one or more of before the instruction: (1) “Apply accelerator.” has been provided to the operator in a visual manner on the head up display 268 or (2) the fourth time (t₄) (at which the accelerator pedal haptic actuator 280 has been activated).

Additionally, for example, the communications module 310 can further include instructions to cause, after the instruction has been provided, a message to be provided to the operator to train the operator to perform the second iteration or the third iteration. For example, the message can be different from the response to the query. For example, the instructions to cause the message to be provided to the operator can include instructions to cause the message to be provided to the operator in one or more of an audible manner, a visual manner, or a haptic manner. For example, the instructions to cause the message to be provided to the operator can include instructions to cause the message to be provided to the operator during the second iteration. Alternatively, for example, the instructions to cause the message to be provided to the operator can include instructions to cause the message to be provided to the operator after the second iteration.

With reference to FIGS. 1-4, for example, the vehicle can be the fourth vehicle 132 (i.e., the vehicle 200), the system 300 can be the system 290, and the instruction can be with respect to a performance of the sharp right turn through the first sharp turn 114. For example, the instructions, “Sharp right turn. See head up display. Pay attention to vibratory signals.” can be provided in an audible manner through the speaker 262. For example, the instructions, “Apply brakes. Steer to the right. Apply accelerator.” can be provided in a visual manner on the head up display 268. For example, instructions can be provided in a haptic manner as follows: (1) the brake pedal haptic actuator 276 can be activated from the first time (t₁) to the third time (t₃), (2) the steering wheel haptic actuator 270 can be activated from the second time (t₂) to the fifth time (t₅), and (3) the accelerator pedal haptic actuator 280 can be activated from the fourth time (t₄) to the sixth time (t₆). Additionally, for example, the messages “Apply more acceleration. Expect the rear wheels to skid.” can be provided to the operator in an audible manner through the speaker 262, in a visual manner on the console display 266, or both. Additionally, for example, the message to the operator can be provided in a haptic manner as follows: (1) the accelerator pedal haptic actuator 280 can be activated at a time at which more acceleration should be applied or (2) if the accelerator pedal haptic actuator 280 has been activated, then an intensity of an energy produced by the accelerator pedal haptic actuator 280 can be changed.

With reference to FIG. 5, for example, the second graph 504 can include a second annotation 508. For example, the second annotation 508 can be with respect to a time at which more acceleration should be applied.

Additionally, for example, the memory 304 can further store a query processing module 312. For example, the query processing module 312 can include instructions that function to control the processor 302 to cause the query to be processed using a machine learning model. For example, the machine learning model can have been developed using: (1) statistics that compare measurements of performances of the maneuver by the operator with a reference performance of the maneuver, (2) sample queries about the performances of the maneuver, and (3) sample responses to the sample queries.

For example, the statistics that compare the measurements of the performances of the maneuver by the operator with the reference performance of the maneuver can indicate that, for different portions of the maneuver, measurements within specific ranges can be associated with deceleration, steering, acceleration, etc.

For example, the sample queries can be produced from a set of queries using a large language model. For example, the large language model can recognize that the operator can express essentially the same query using different expressions. For example, using the large language model, the set of queries: (1) “When do I accelerate?” (2) “Should I accelerate now?” and (3) “How soon should I accelerate?” can produce the sample query “At what time should acceleration start?” For example, using the large language model, the instructions to cause the query to be processed using the machine learning model can cause a same response to each member of the set of queries.

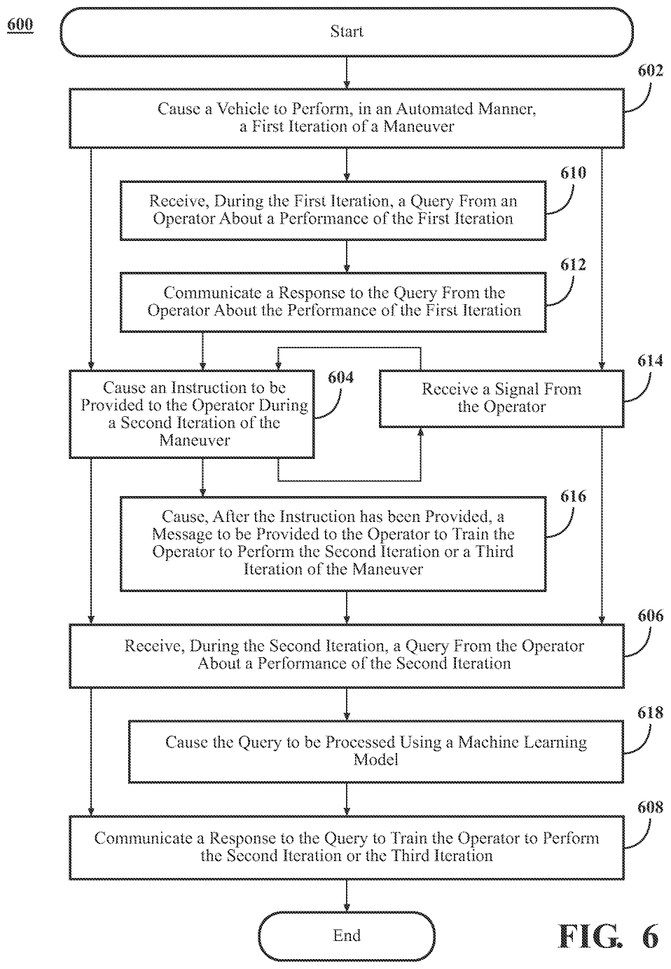

FIG. 6 includes a flow diagram that illustrates an example of a method 600 that is associated with training an operator of a vehicle to perform a maneuver of the vehicle, according to the disclosed technologies. For example, a performance of the maneuver can include a sequence of operations of various car controls. Although the method 600 is described in combination with the system 300 illustrated in FIG. 3, one of skill in the art understands, in light of the description herein, that the method 600 is not limited to being implemented by the system 300 illustrated in FIG. 3. Rather, the system 300 illustrated in FIG. 3 is an example of a system that may be used to implement the method 600. Additionally, although the method 600 is illustrated as a generally serial process, various aspects of the method 600 may be able to be executed in parallel.

In FIG. 6, in the method 600, at an operation 602, for example, the automated motion module 306 can cause the vehicle to perform, in an automated manner, a first iteration of the maneuver.

At an operation 604, for example, the instruction module 308 can cause an instruction to be provided to the operator during a second iteration of the maneuver.

At an operation 606, for example, the communications module 310 can receive, during the second iteration, a query from the operator about a performance of the second iteration.

At an operation 608, for example, the communications module 310 can communicate a response to the query to train the operator to perform the second iteration or a third iteration of the maneuver in a manner that mimics the first iteration.

For example, the vehicle can be switchable: (1) from a first mode to a second mode and (2) from the second mode to the first mode. For example, the first mode can be a mode in which car controls, required to perform the maneuver, are configured to operate under a control of the operator. For example, the second mode can be a mode in which the car controls, required to perform the maneuver, are configured to operate automatically. Alternatively, for example, the second mode can be a mode in which the vehicle is configured to operate autonomously.

For example, at the operation 604, the instruction module 308 can cause the instruction to be provided to the operator in one or more of an audible manner, a visual manner, or a haptic manner.

For example, at the operation 608, the communications module 310 can communicate the response to the query in one or more of an audible manner, a visual manner, or a haptic manner.

For example, at the operation 608, the communications module 310 can communicate the response to the query during the second iteration.

Additionally or alternatively, for example, at the operation 608, the communications module 310 can communicate the response to the query after the second iteration.

For example, at the operation 608, the communications module 310 can communicate, to an external communications device, the response to the query.

For example, one or more of the instruction provided to the operator or the response to the query can be based on a result of a comparison of a measurement of a performance of the maneuver by the operator and a measurement of a performance of the maneuver in the automated manner.

For example, at the operation 608, the communications module 310 can communicate the response to the query in response to the result of the comparison being greater than a threshold.

For example, the performance of the maneuver by the operator can produce an operator trajectory. For example, the performance of the maneuver in the automated manner can produce a reference trajectory. For example, the result of the comparison can include a measurement of a degree of adherence of the operator trajectory to the reference trajectory.

For example, the reference trajectory can include a trajectory of the maneuver performed in the automated manner to mimic one or more of: (1) an example trajectory of the maneuver performed by an expert operator, (2) a trajectory produced by a trajectory planning stage of an automated motion technology system of the vehicle, or (3) a trajectory produced by an optimal control system of the automated motion technology system. For example, the optimal control system can be a model predictive control system.

For example, one or more of: (1) the trajectory produced by the trajectory planning stage or (2) the trajectory produced by the optimal control system can be produced by optimizing an objective function. For example, a significant constraint of the objective function can be one or more of: (1) a duration of time to complete the maneuver or (2) a measurement of a degree of safety associated with the performance of the maneuver.

Additionally, at an operation 610, for example, the communications module 310 can receive, during the first iteration of the maneuver performed in the automated manner, a query from the operator about a performance of the first iteration.

Additionally, at an operation 612, for example, the communications module 310 can communicate a response to the query from the operator about the performance of the first iteration. For example, at the operation 612, the communications module 310 can communicate the response to the query from the operator about the performance of the first iteration in one or more of an audible manner, a visual manner, or a haptic manner.

Additionally, at an operation 614, for example, the communications module 310 can receive a signal from the operator. For example, the signal can be different from the query. For example, at the operation 614, the communications module 310 can receive the signal from the operator via one or more of a steering operator interface, a brake operator interface, an acceleration operator interface, or a transmission operator interface. For example, at the operation 614, the communications module 310 can receive the signal from the operator before the instruction has been provided to the operator. Alternatively, for example, at the operation 614, the communications module 310 can receive the signal from the operator after the instruction has been provided to the operator.

Additionally, at an operation 616, for example, the communications module 310 can cause, after the instruction has been provided, a message to be provided to the operator to train the operator to perform the second iteration or the third iteration. For example, the message can be different from the response to the query. For example, at the operation 616, the communications module 310 can cause the message to be provided to the operator in one or more of an audible manner, a visual manner, or a haptic manner. For example, at the operation 616, the communications module 310 can cause the message to be provided to the operator during the second iteration. Alternatively, for example, at the operation 616, the communications module 310 can cause the message to be provided to the operator after the second iteration.

Additionally, at an operation 618, for example, the query processing module 312 can cause the query to be processed using a machine learning model. For example, the machine learning model can have been developed using: (1) statistics that compare measurements of performances of the maneuver by the operator with a reference performance of the maneuver, (2) sample queries about the performances of the maneuver, and (3) sample responses to the sample queries. For example, the sample queries can be produced from a set of queries using a large language model.

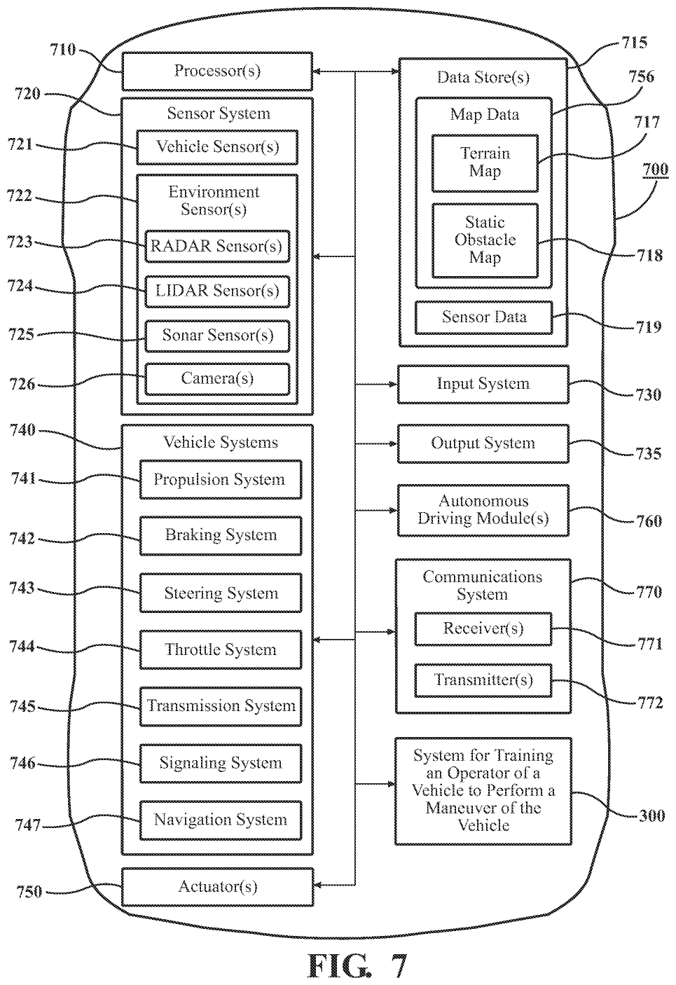

FIG. 7 includes a block diagram that illustrates an example of elements disposed on a vehicle 700, according to the disclosed technologies. As used herein, a “vehicle” can be any form of powered transport. In one or more implementations, the vehicle 700 can be an automobile. While arrangements described herein are with respect to automobiles, one of skill in the art understands, in light of the description herein, that embodiments are not limited to automobiles. For example, functions and/or operations of one or more of the first vehicle 126 (illustrated in FIG. 1), the second vehicle 128 (illustrated in FIG. 1), the third vehicle 130 (illustrated in FIG. 1), the fourth vehicle 132 (illustrated in FIG. 1), or the vehicle 200 (illustrated in FIG. 2) can be realized by the vehicle 700.

In some embodiments, the vehicle 700 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 700 is performed according to inputs received from a user (e.g., human driver). In one or more arrangements, the vehicle 700 can be a conventional vehicle that is configured to operate in only a manual mode.

In one or more embodiments, the vehicle 700 can be an automated vehicle. As used herein, “automated vehicle” can refer to a vehicle that operates in an automated mode. As used herein, “automated mode” can refer to navigating and/or maneuvering the vehicle 700 along a travel route using one or more computing systems to control the vehicle 700 with minimal or no input from a human driver. In one or more embodiments, the vehicle 700 can be highly automated or completely automated. In one embodiment, the vehicle 700 can be configured with one or more semi-automated operational modes in which one or more computing systems perform a portion of the navigation and/or maneuvering of the vehicle along a travel route, and a vehicle operator (i.e., driver) provides inputs to the vehicle 700 to perform a portion of the navigation and/or maneuvering of the vehicle 700 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 700 can include various elements. The vehicle 700 can have any combination of the various elements illustrated in FIG. 7. In various embodiments, it may not be necessary for the vehicle 700 to include all of the elements illustrated in FIG. 7. Furthermore, the vehicle 700 can have elements in addition to those illustrated in FIG. 7. While the various elements are illustrated in FIG. 7 as being located within the vehicle 700, one or more of these elements can be located external to the vehicle 700. Furthermore, the elements illustrated may be physically separated by large distances. For example, as described, one or more components of the disclosed system can be implemented within the vehicle 700 while other components of the system can be implemented within a cloud-computing environment, as described below. For example, the elements can include one or more processors 710, one or more data stores 715, a sensor system 720, an input system 730, an output system 735, vehicle systems 740, one or more actuators 750, one or more automated driving modules 760, a communications system 770, and the system 300 for training an operator of the vehicle 700 to perform a maneuver of the vehicle 700.

In one or more arrangements, the one or more processors 710 can be a main processor of the vehicle 700. For example, the one or more processors 710 can be an electronic control unit (ECU). For example, functions and/or operations of the processor 302 (illustrated in FIG. 3) can be realized by the one or more processors 710.

The one or more data stores 715 can store, for example, one or more types of data. The one or more data stores 715 can include volatile memory and/or non-volatile memory. Examples of suitable memory for the one or more data stores 715 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 715 can be a component of the one or more processors 710. Additionally or alternatively, the one or more data stores 715 can be operatively connected to the one or more processors 710 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation. For example, functions and/or operations of the memory 304 (illustrated in FIG. 3) can be realized by the one or more data stores 715.

In one or more arrangements, the one or more data stores 715 can store map data 716. The map data 716 can include maps of one or more geographic areas. In some instances, the map data 716 can include information or data on roads, traffic control devices, road markings, structures, features, and/or landmarks in the one or more geographic areas. The map data 716 can be in any suitable form. In some instances, the map data 716 can include aerial views of an area. In some instances, the map data 716 can include ground views of an area, including 360-degree ground views. The map data 716 can include measurements, dimensions, distances, and/or information for one or more items included in the map data 716 and/or relative to other items included in the map data 716. The map data 716 can include a digital map with information about road geometry. The map data 716 can be high quality and/or highly detailed.

In one or more arrangements, the map data 716 can include one or more terrain maps 717. The one or more terrain maps 717 can include information about the ground, terrain, roads, surfaces, and/or other features of one or more geographic areas. The one or more terrain maps 717 can include elevation data of the one or more geographic areas. The map data 716 can be high quality and/or highly detailed. The one or more terrain maps 717 can define one or more ground surfaces, which can include paved roads, unpaved roads, land, and other things that define a ground surface.

In one or more arrangements, the map data 716 can include one or more static obstacle maps 718. The one or more static obstacle maps 718 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 718 can have location data, size data, dimension data, material data, and/or other data associated with them. The one or more static obstacle maps 718 can include measurements, dimensions, distances, and/or information for one or more static obstacles. The one or more static obstacle maps 718 can be high quality and/or highly detailed. The one or more static obstacle maps 718 can be updated to reflect changes within a mapped area.

In one or more arrangements, the one or more data stores 715 can store sensor data 719. As used herein, “sensor data” can refer to any information about the sensors with which the vehicle 700 can be equipped including the capabilities of and other information about such sensors. The sensor data 719 can relate to one or more sensors of the sensor system 720. For example, in one or more arrangements, the sensor data 719 can include information about one or more lidar sensors 724 of the sensor system 720.

In some arrangements, at least a portion of the map data 716 and/or the sensor data 719 can be located in one or more data stores 715 that are located onboard the vehicle 700. Additionally or alternatively, at least a portion of the map data 716 and/or the sensor data 719 can be located in one or more data stores 715 that are located remotely from the vehicle 700.

The sensor system 720 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 720 includes a plurality of sensors, the sensors can work independently from each other. Alternatively, two or more of the sensors can work in combination with each other. In such a case, the two or more sensors can form a sensor network. The sensor system 720 and/or the one or more sensors can be operatively connected to the one or more processors 710, the one or more data stores 715, and/or another element of the vehicle 700 (including any of the elements illustrated in FIG. 7). The sensor system 720 can acquire data of at least a portion of the external environment of the vehicle 700 (e.g., nearby vehicles). The sensor system 720 can include any suitable type of sensor. Various examples of different types of sensors are described herein. However, one of skill in the art understands that the embodiments are not limited to the particular sensors described herein.

The sensor system 720 can include one or more vehicle sensors 721. The one or more vehicle sensors 721 can detect, determine, and/or sense information about the vehicle 700 itself. In one or more arrangements, the one or more vehicle sensors 721 can be configured to detect and/or sense position and orientation changes of the vehicle 700 such as, for example, based on inertial acceleration. In one or more arrangements, the one or more vehicle sensors 721 can include one or more accelerometers, one or more gyroscopes, an inertial measurement unit (IMU), a dead-reckoning system, a global navigation satellite system (GNSS), a global positioning system (GPS), a navigation system 747, and/or other suitable sensors. The one or more vehicle sensors 721 can be configured to detect and/or sense one or more characteristics of the vehicle 700. In one or more arrangements, the one or more vehicle sensors 721 can include a speedometer to determine a current speed of the vehicle 700.

Additionally or alternatively, the sensor system 720 can include one or more environment sensors 722 configured to acquire and/or sense driving environment data. As used herein, “driving environment data” can include data or information about the external environment in which a vehicle is located or one or more portions thereof. For example, the one or more environment sensors 722 can be configured to detect, quantify, and/or sense obstacles in at least a portion of the external environment of the vehicle 700 and/or information/data about such obstacles. Such obstacles may be stationary objects and/or dynamic objects. The one or more environment sensors 722 can be configured to detect, measure, quantify, and/or sense other things in the external environment of the vehicle 700 such as, for example, lane markers, signs, traffic lights, traffic signs, lane lines, crosswalks, curbs proximate the vehicle 700, off-road objects, etc.

Various examples of sensors of the sensor system 720 are described herein. The example sensors may be part of the one or more vehicle sensors 721 and/or the one or more environment sensors 722. However, one of skill in the art understands that the embodiments are not limited to the particular sensors described.

In one or more arrangements, the one or more environment sensors 722 can include one or more radar sensors 723, one or more lidar sensors 724, one or more sonar sensors 725, and/or one more cameras 726. In one or more arrangements, the one or more cameras 726 can be one or more high dynamic range (HDR) cameras or one or more infrared (IR) cameras. For example, the one or more cameras 726 can be used to record a reality of a state of an item of information that can appear in the digital map.

The input system 730 can include any device, component, system, element, arrangement, or groups thereof that enable information/data to be entered into a machine. The input system 730 can receive an input from a vehicle passenger (e.g., a driver or a passenger). The output system 735 can include any device, component, system, element, arrangement, or groups thereof that enable information/data to be presented to a vehicle passenger (e.g., a driver or a passenger). For example, functions and/or operations of the microphone 286 (illustrated in FIG. 2) can be realized by the input system 730. For example, functions and/or operations of the speaker 262 (illustrated in FIG. 2), the display 264 (illustrated in FIG. 2), the console display 266 (illustrated in FIG. 2), head up display 268 (illustrated in FIG. 2), the steering wheel haptic actuator 270 (illustrated in FIG. 2), the joystick-like control lever left turn haptic actuator 272 (illustrated in FIG. 2), the joystick-like control lever right turn haptic actuator 274 (illustrated in FIG. 2), the brake pedal haptic actuator 276 (illustrated in FIG. 2), the joystick-like control lever brake haptic actuator 278 (illustrated in FIG. 2), the accelerator pedal haptic actuator 280 (illustrated in FIG. 2), the joystick-like control lever acceleration haptic actuator 282 (illustrated in FIG. 2), or the clutch pedal haptic actuator 284 (illustrated in FIG. 2) can be realized by the output system 735.

Various examples of the one or more vehicle systems 740 are illustrated in FIG. 7. However, one of skill in the art understands that the vehicle 700 can include more, fewer, or different vehicle systems. Although particular vehicle systems can be separately defined, each or any of the systems or portions thereof may be otherwise combined or segregated via hardware and/or software within the vehicle 700. For example, the one or more vehicle systems 740 can include a propulsion system 741, a braking system 742, a steering system 743, a throttle system 744, a transmission system 745, a signaling system 746, and/or the navigation system 747. Each of these systems can include one or more devices, components, and/or a combination thereof, now known or later developed. For example, functions and/or operations of the internal combustion engine 208 (illustrated in FIG. 2) or the electric drive motor 210 (illustrated in FIG. 2) can be realized by the propulsion system 741. For example, functions and/or operations of the brakes 206 (illustrated in FIG. 2) can be realized by the braking system 742. For example, functions and/or operations of the steering linkage 204 (illustrated in FIG. 2) can be realized by the steering system 743. For example, functions and/or operations of the transmission system 212 (illustrated in FIG. 2) can be realized by the transmission system 745.

The navigation system 747 can include one or more devices, applications, and/or combinations thereof, now known or later developed, configured to determine the geographic location of the vehicle 700 and/or to determine a travel route for the vehicle 700. The navigation system 747 can include one or more mapping applications to determine a travel route for the vehicle 700. The navigation system 747 can include a global positioning system, a local positioning system, a geolocation system, and/or a combination thereof.

The one or more actuators 750 can be any element or combination of elements operable to modify, adjust, and/or alter one or more of the vehicle systems 740 or components thereof responsive to receiving signals or other inputs from the one or more processors 710 and/or the one or more automated driving modules 760. Any suitable actuator can be used. For example, the one or more actuators 750 can include motors, pneumatic actuators, hydraulic pistons, relays, solenoids, and/or piezoelectric actuators. For example, functions and/or operations of the car controls 214 (illustrated in FIG. 2), the actuator 216 (illustrated in FIG. 2), the actuator 218 (illustrated in FIG. 2), the actuator 220 (illustrated in FIG. 2), or the actuator 222 (illustrated in FIG. 2) can be realized by the one or more actuators 750.

The one or more processors 710 and/or the one or more automated driving modules 760 can be operatively connected to communicate with the various vehicle systems 740 and/or individual components thereof. For example, the one or more processors 710 and/or the one or more automated driving modules 760 can be in communication to send and/or receive information from the various vehicle systems 740 to control the movement, speed, maneuvering, heading, direction, etc. of the vehicle 700. The one or more processors 710 and/or the one or more automated driving modules 760 may control some or all of these vehicle systems 740 and, thus, may be partially or fully automated.

The one or more processors 710 and/or the one or more automated driving modules 760 may be operable to control the navigation and/or maneuvering of the vehicle 700 by controlling one or more of the vehicle systems 740 and/or components thereof. For example, when operating in an automated mode, the one or more processors 710 and/or the one or more automated driving modules 760 can control the direction and/or speed of the vehicle 700. The one or more processors 710 and/or the one or more automated driving modules 760 can cause the vehicle 700 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 770 can include one or more receivers 771 and/or one or more transmitters 772. The communications system 770 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 770 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies. For example, functions and/or operations of the communications device 142 (illustrated in FIG. 1), the communications device 144 (illustrated in FIG. 1), or the communications device 288 (illustrated in FIG. 2) can be realized by the communications system 770.

Moreover, the one or more processors 710, the one or more data stores 715, and the communications system 770 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 700 can include one or more modules, at least some of which are described herein. The modules can be implemented as computer-readable program code that, when executed by the one or more processors 710, implement one or more of the various processes described herein. One or more of the modules can be a component of the one or more processors 710. Additionally or alternatively, one or more of the modules can be executed on and/or distributed among other processing systems to which the one or more processors 710 can be operatively connected. The modules can include instructions (e.g., program logic) executable by the one or more processors 710. Additionally or alternatively, the one or more data store 715 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 700 can include one or more automated driving modules 760. The one or more automated driving modules 760 can be configured to receive data from the sensor system 720 and/or any other type of system capable of capturing information relating to the vehicle 700 and/or the external environment of the vehicle 700. In one or more arrangements, the one or more automated driving modules 760 can use such data to generate one or more driving scene models. The one or more automated driving modules 760 can determine position and velocity of the vehicle 700. The one or more automated driving modules 760 can determine the location of obstacles, obstacles, or other environmental features including traffic signs, trees, shrubs, neighboring vehicles, pedestrians, etc.

The one or more automated driving modules 760 can be configured to receive and/or determine location information for obstacles within the external environment of the vehicle 700 for use by the one or more processors 710 and/or one or more of the modules described herein to estimate position and orientation of the vehicle 700, vehicle position in global coordinates based on signals from a plurality of satellites, or any other data and/or signals that could be used to determine the current state of the vehicle 700 or determine the position of the vehicle 700 with respect to its environment for use in either creating a map or determining the position of the vehicle 700 in respect to map data.

The one or more automated driving modules 760 can be configured to determine one or more travel paths, current automated driving maneuvers for the vehicle 700, future automated driving maneuvers and/or modifications to current automated driving maneuvers based on data acquired by the sensor system 720, driving scene models, and/or data from any other suitable source such as determinations from the sensor data 719. As used herein, “driving maneuver” can refer to one or more actions that affect the movement of a vehicle. Examples of driving maneuvers include: accelerating, decelerating, braking, turning, moving in a lateral direction of the vehicle 700, changing travel lanes, merging into a travel lane, and/or reversing, just to name a few possibilities. The one or more automated driving modules 760 can be configured to implement determined driving maneuvers. The one or more automated driving modules 760 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 760 can be configured to execute various vehicle functions and/or to transmit data to, receive data from, interact with, and/or control the vehicle 700 or one or more systems thereof (e.g., one or more of vehicle systems 740). For example, functions and/or operations of an automotive navigation system can be realized by the one or more automated driving modules 760.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-7, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
an automated motion module including instructions that, when executed by the processor, cause the processor to cause a vehicle to perform, in an automated manner, a first iteration of a maneuver;
an instruction module including instructions that, when executed by the processor, cause the processor to cause an instruction to be provided to an operator of the vehicle during a second iteration of the maneuver; and
a communications module including instructions that, when executed by the processor, cause the processor to:
receive, during the second iteration, a query from the operator about a performance of the second iteration; and
communicate a response to the query to train the operator to perform the second iteration or a third iteration of the maneuver in a manner that mimics the first iteration.

2. The system of claim 1, wherein:
the vehicle is configured to be switchable:
from a first mode to a second mode, and
from the second mode to the first mode,
the first mode is a mode in which car controls, required to perform the maneuver, are configured to operate under a control of the operator, and
the second mode is a mode in which the car controls, required to perform the maneuver, are configured to operate automatically.

3. The system of claim 1, wherein:
the vehicle is configured to be switchable:
from a first mode to a second mode, and
from the second mode to the first mode,
the first mode is a mode in which car controls, required to perform the maneuver, are configured to operate under a control of the operator, and
the second mode is a mode in which the vehicle is configured to operate autonomously.

4. The system of claim 1, wherein the instructions to communicate the response to the query include instructions to communicate, to an external communications device, the response to the query.

5. The system of claim 1, wherein at least one of the instruction provided to the operator or the response to the query is based on a result of a comparison of a measurement of a performance of the maneuver by the operator and a measurement of a performance of the maneuver in the automated manner.

6. The system of claim 5, wherein the instructions to communicate the response to the query include instructions to communicate the response to the query in response to the result of the comparison being greater than a threshold.

7. The system of claim 5, wherein:
the performance of the maneuver by the operator produces an operator trajectory,
the performance of the maneuver in the automated manner produces a reference trajectory, and
the result of the comparison comprises a measurement of a degree of adherence of the operator trajectory to the reference trajectory.

8. The system of claim 7, wherein the reference trajectory comprises a trajectory of the maneuver performed in the automated manner to mimic at least one of:
an example trajectory of the maneuver performed by an expert operator,
a trajectory produced by a trajectory planning stage of an automated motion technology system of the vehicle, or
a trajectory produced by an optimal control system of the automated motion technology system.

9. The system of claim 8, wherein the optimal control system is a model predictive control system.

10. The system of claim 8, wherein at least one of the trajectory produced by the trajectory planning stage or the trajectory produced by the optimal control system is produced by optimizing an objective function.

11. The system of claim 10, wherein a significant constraint of the objective function is at least one of a duration of time to complete the maneuver or a measurement of a degree of safety associated with the performance of the maneuver.

12. The system of claim 1, wherein the communications module further includes instructions to:
receive, during the first iteration, a query from the operator about a performance of the first iteration; and
communicate a response to the query from the operator about the performance of the first iteration.

13. The system of claim 1, wherein the communications module further includes instructions to receive a signal from the operator, wherein the signal is different from the query.

14. The system of claim 13, wherein the instructions to receive the signal from the operator include instructions to receive the signal from the operator via at least one of a steering operator interface, a brake operator interface, an acceleration operator interface, or a transmission operator interface.

15. The system of claim 1, wherein the communications module further includes instructions to cause, after the instruction has been provided, a message to be provided to the operator to train the operator to perform the second iteration or the third iteration, wherein the message is different from the response to the query.

16. A method, comprising:
causing, by a processor, a vehicle to perform, in an automated manner, a first iteration of a maneuver;
causing, by the processor, an instruction to be provided to an operator of the vehicle during a second iteration of the maneuver;
receiving, by the processor and during the second iteration, a query from the operator about a performance of the second iteration; and
communicating, by the processor, a response to the query to train the operator to perform the second iteration or a third iteration of the maneuver in a manner that mimics the first iteration.

17. The method of claim 16, wherein a performance of the maneuver comprises a sequence of operations of various car controls.

18. The method of claim 16, further comprising causing, by the processor, the query to be processed using a machine learning model developed using:
statistics that compare measurements of performances of the maneuver by the operator with a reference performance of the maneuver,
sample queries about the performances of the maneuver, and
sample responses to the sample queries.

19. The method of claim 18, wherein the sample queries are produced from a set of queries using a large language model.

20. A non-transitory computer-readable medium for training an operator of a vehicle to perform a maneuver of the vehicle, the non-transitory computer-readable medium including instructions that, when executed by one or more processors, cause the one or more processors to:
cause a vehicle to perform, in an automated manner, a first iteration of a maneuver;
cause an instruction to be provided to an operator of the vehicle during a second iteration of the maneuver;
receive, during the second iteration, a query from the operator about a performance of the second iteration; and
communicate a response to the query to train the operator to perform the second iteration or a third iteration of the maneuver in a manner that mimics the first iteration.
